(19) United States
(12) Patent Application Publication
(10) Pub. No.: US 2022/0020014 A1
(43) Pub. Date: Jan. 20, 2022

(54) Transaction mode-based electronic contract preservation system

(71) Applicant: Jiangsu Aowei Holdings Co., Ltd., Nanjing (CN)

(72) Inventor: Jie Bai, Nanjing (CN)

(21) Appl. No.: 17/378,830

(22) Filed: Jul. 19, 2021

(30) Foreign Application Priority Data
Jul. 20, 2020 (CN) 202010700271.3
Sep. 9, 2020 (CN) 202010938201.1

(51) Int. Cl. G06Q 20/38; H04L 9/08; H04L 9/32

(52) U.S. Cl. CPC G06Q 20/38215; G06Q 20/3823; G06Q 20/3829; G06Q 20/3825; G06Q 20/3827; H04L 2209/56; H04L 9/3263; H04L 9/3247; H04L 9/3236; G06Q 2220/00; H04L 2209/38; H04L 9/0825

(57) ABSTRACT

This application discloses a transaction-based electronic contract deposit system, including an electronic contract platform and a blockchain deposit platform, the blockchain deposit platform including a plurality of deposit nodes that provide deposit services for the electronic contract platform. In this way, the following problem may be resolved: regarding an existing manner of storing an electronic contract in a centralized way, during a subsequent process of invoking electronic contract data, the stored electronic contract data becomes untrustworthy because the contract data is at a risk of being easily tampered with and forged.

This application claims the priority to the Chinese Application No.202010700271.3, filed with the Chinese Patent Office on Jul. 20, 2020 and entitled “TRANSACTION-BASED ELECTRONIC CONTRACT DEPOSIT SYSTEM”, which is incorporated herein by references in its entirety.

### FIELD OF THE INVENTION

This application relates to the field of electronic contract deposit technologies, and in particular, to a transaction-based electronic contract deposit system.

### BACKGROUND OF THE INVENTION

With development of the Internet era, at present, an electronic contract is signed and sealed by an electronic contract platform using a certificate issued by a certificate authority (CA) of a user, having same legal effects. In this way, the electronic contract, as a contract, is gradually widely used.

However, at present, a database storage platform is usually used to store the electronic contract. Such storage manner is essentially centralized storage, and contract data is at a risk of being easily tampered with and forged. Therefore, during a subsequent process of invoking the electronic contract data, the stored electronic contract data becomes untrustworthy. As a result, the storage of the electronic contract data becomes meaningless.

### SUMMARY OF THE INVENTION

This application provides a transaction-based electronic contract deposit system, and may resolve the following problem: regarding an existing manner of storing an electronic contract in a centralized way, during a subsequent process of invoking electronic contract data, the stored electronic contract data becomes untrustworthy because the contract data is at a risk of being easily tampered with and forged.

A transaction-based electronic contract deposit system, including an electronic contract platform and a blockchain deposit platform, the blockchain deposit platform including a plurality of deposit nodes that provide deposit services for the electronic contract platform, where
the electronic contract platform is configured to perform:
a deposit information generating step: preprocessing an electronic contract, to obtain deposit information;
a data processing step: encrypting and discretizing the deposit information, to generate a corresponding data tree, where the deposit information includes a contract operation result, an electronic contract certificate, and a signed certificate;
a transaction constructing step: constructing a deposit transaction, where an initiator of the deposit transaction is a user, a receiver is the electronic contract platform, and the deposit transaction is commonly signed by a private key of the user and a private key of the electronic contract platform; and
a data sending step: sending the deposit information, the data tree, and the deposit transaction to the blockchain deposit platform; and
the deposit node is configured to perform:
a verifying step: verifying legitimacy, integrity, and validity of the received deposit information, data tree, and deposit transaction by using a public key of the user and a public key of the electronic contract platform;
a data block generating step: generating a data block based on the deposit information, the data tree, and the deposit transaction, and stamping the data block with a time stamp;
a step of uploading and storing on a chain: uploading and storing the deposit information, the data tree, the deposit transaction, and the data block on a chain;
a transaction hash operation step: performing a hash operation on the deposit transaction, to obtain a transaction hash value;
a step of transmitting data back: transmitting the deposit information, the data tree, the deposit transaction, the data block, and the transaction hash value back to the electronic contract platform; and
a step of continuing to transmit the data: transmitting the deposit information, the data tree, the deposit transaction, the data block, and the transaction hash value to a next deposit node.

It may be learned from the foregoing technical solution that the transaction-based electronic contract deposit system provided in this application includes the electronic contract platform and the blockchain deposit platform, the blockchain deposit platform including a plurality of deposit nodes that provide deposit services for the electronic contract platform. According to the transaction-based electronic contract deposit system in this application, the electronic contract platform is combined with the blockchain technology to deposit the electronic contract. The credibility of electronic contract deposit is ensured by using features of a blockchain, such as decentralization, cannot be tampered with, leaving tracks throughout the process, being traceable, being collectively maintained, and being open and transparent. By constructing the deposit transaction, a deposit behavior of uploading the electronic contract to the blockchain deposit platform is recorded. First, electronic contract-related data sent to the blockchain deposit platform is encrypted and discretized, and the data tree is generated, thereby being more benifical to anti-tampering of the data, and enhancing security and privacy during a data transmission process. By means of signing by using the private key and verifying by using the public key, the credibility of the electronic contract deposit process is further enhanced, to prevent the electronic contract from being tampered with and forged. When a contract dispute occurs, technically, it may be guaranteed that no party involved in the electronic contract can tamper with the contract.

### BRIEF DESCRIPTION OF THE DRAWINGS

To more clearly describe the technical solutions of this application, the accompanying drawings to be used in the embodiments are briefly illustrated below. Obviously, persons of ordinary skills in the art can also derive other accompanying drawings according to these accompanying drawings without an creative effort.

FIG. 1 is a topology view of a first transaction-based electronic contract deposit system according to an embodiment of this application;

FIG. 2 is a data processing flowchart of the transaction-based electronic contract deposit system shown in FIG. 1;

FIG. 3 is a flowchart of method steps corresponding to the data processing flowchart shown in FIG. 2;

FIG. 4 is a corresponding flowchart of data splitting of a second transaction-based electronic contract deposit system according to an embodiment of this application; and

FIG. 5 is a corresponding flowchart of data splitting of a third transaction-based electronic contract deposit system according to an embodiment of this application.

### DETAILED DESCRIPTION OF THE EMBODIMENTS

The technical solutions in the embodiments of this application are clearly and completely described below in combination with the accompanying drawings in the embodiments of this application. Obviously, the described embodiments are merely some embodiments of this application and are not all embodiments. According to the embodiments of this application, all other embodiments derived by persons of ordinary skills in the art without an creative effort fall within the protection scope of this application.

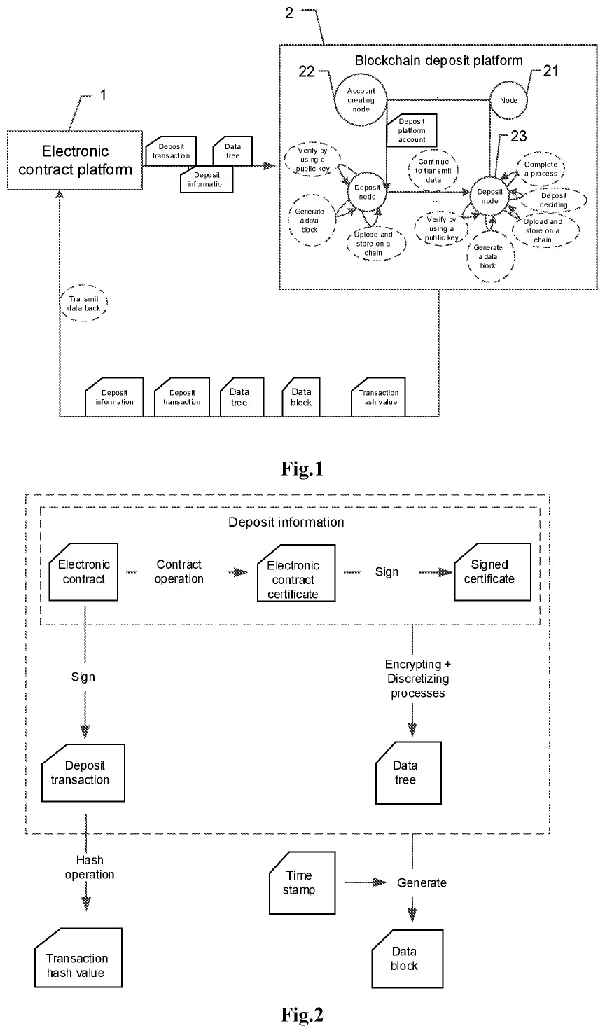

FIG. 1 is a topology view of a first transaction-based electronic contract deposit system according to an embodiment of this application. As shown in FIG. 1, the transaction-based electronic contract deposit system provided in this embodiment includes an electronic contract platform 1 and a blockchain deposit platform 2 that are communicatively connected to each other. The blockchain deposit platform 2 includes a plurality of nodes 21 that are capable of peer-to-peer communication. At least one node 21 serves as an account creating node 22, to provide account creating services for the electronic contract platform 1. A plurality of nodes 21 serve as deposit nodes 23, to provide deposit services for the electronic contract platform 1. Basic information of deposit data of the electronic contract may be as shown in the following table 1. Table 1 is a comparison table of the basic information of the deposit data of the electronic contract.

TABLE 1

| Name | Field content | Postscript content |
|---|---|---|
| User | User ID | User ID and user IP |
| registration | | |
| information | | |
| Personal | Name, ID | User ID, user IP, and ID number |
| identity | number, | |
| information | mobile | |
| | number, and | |
| | bank card | |
| | number | |
| Enterprise | Company | User ID, user IP, and enterprise |
| real-name | name and | organization code |
| information | enterprise | |
| | organization | |
| | code | |
| Digital | CA certificate | User ID, user IP, CA certificate |
| certificate | file | file name, and CA organization |
| issuing | | |
| information | | |
| Deposit | Mobile | User ID, user IP, contract |
| information | number, SMS | number, and signatories (party A |
| about signing | text | and party B) |
| willingness | | |
| Contract | Contractual | Contract number, contract name, |
| signing | document | user ID of party A, and user ID of |
| information | | party B |
| System log | Log file | File name, log creation date (in a |
| information | | YYYY-MM-DD format) |

It should be noted that the electronic contract platform 1 and the blockchain deposit platform 2 that are described in this application respectively may be one of a public chain, a subchain, or a consortium chain that are communicatively connected to a certain blockchain or a plurality of blockchains. The electronic contract platform 1 may be a functional subchain or a consortium chain; the blockchain deposit platform 2 may be a public chain, a functional subchain, or a consortium chain; and the electronic contract platform 1 may alternatively be an existing Internet of Things platform. This is not specifically limited in this application.

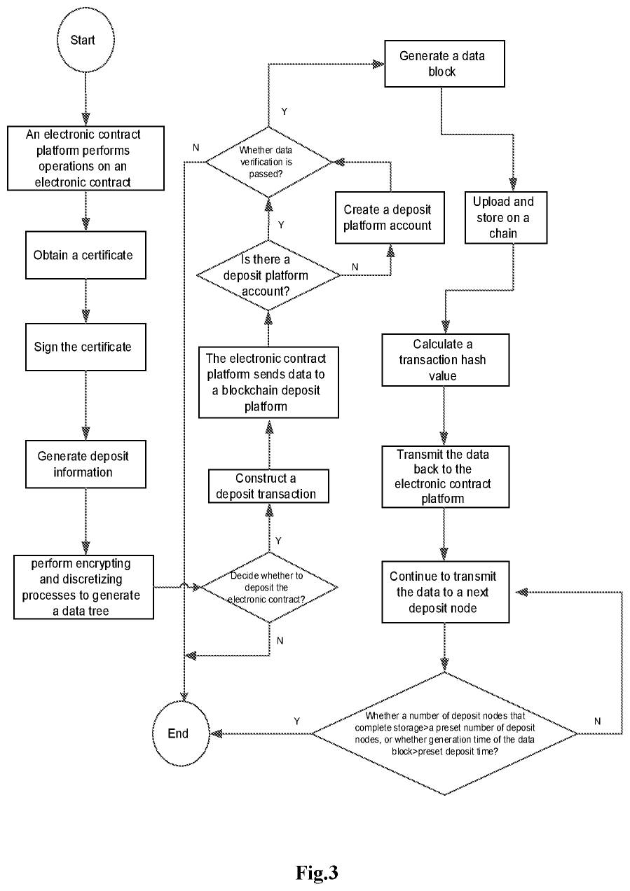

FIG. 2 is a data processing flowchart of the transaction-based electronic contract deposit system shown in FIG. 1. FIG. 3 is a flowchart of method steps corresponding to the data processing flowchart shown in FIG. 2. With reference to FIG. 1 to FIG. 3, the electronic contract platform 1 may be configured to perform:
a deposit information generating step: preprocessing an electronic contract, to obtain deposit information.

The deposit information generating step may further include the following steps:
a contract operating step: performing related operations on the electronic contract, to obtain a contract operation result, where the related operations may include signing, renewal, modification, and termination;
a certificate obtaining step: obtaining an electronic contract certificate corresponding to the contract operation result, where the electronic certificate may be a legal electronic certificate issued by the electronic contract platform 1 or a third-party CA platform; and
a certificate signing step: signing the electronic contract certificate, to obtain a signed certificate. Signature schemes at the certificate signing step may include a local signature, an electronic contract platform signature, and a deposit platform signature. The deposit information may include the contract operation result, the electronic contract certificate, and the signed certificate.

When the signature scheme is the local signature, the electronic contract certificate may be signed by using a private key of a user, to obtain the signed certificate.

When the signature scheme is the electronic contract platform signature, the electronic contract certificate may be signed by using a private key of the electronic contract platform, to obtain the signed certificate.

When the signature scheme is the deposit platform signature, the electronic contract certificate may be signed by using a public key of the blockchain deposit platform, to obtain the signed certificate.

The private key and the public key appear in a one-to-one correspondence. After the electronic contract is signed by using the private key, it may be convenient to restore the signed certificate in the following by using the public key, so as to prepare for the invoking of the electronic contract.

After the deposit information is generated, a data processing step is continued to be performed, to encrypt and discretize the deposit information to generate a corresponding data tree.

Further, the electronic contract platform 1 may be configured to perform an uploading deciding step, to decide whether the electronic contract is deposited in the blockchain deposit platform. When it is decided that the electronic contract is not deposited in the blockchain deposit platform, a deposit process of the electronic contract ends.

When it is decided that the electronic contract is deposited in the blockchain deposit platform, a transaction constructing step is continued to be performed, to construct a deposit transaction. An initiator of the deposit transaction is the user, and a receiver is the electronic contract platform. The deposit transaction is commonly signed by the private key of the user and the private key of the electronic contract platform. The deposit transaction may be used to record a deposit process of the electronic contract.

Finally, a data sending step is performed, to send the deposit information, the data tree, and the deposit transaction to the blockchain deposit platform.

The account creating node 22 is configured to perform:

an account deciding step: deciding whether there is a deposit platform account corresponding to the electronic contract platform on the blockchain deposit platform; and

an account creating step: when there is no deposit platform account corresponding to the electronic contract platform on the blockchain deposit platform, creating a deposit platform account for the electronic contract platform.

When there is no deposit platform account corresponding to the electronic contract platform on the blockchain deposit platform, the deposit node 23 continues to perform a deposit-related step.

The deposit node 23 is configured to perform:

a verifying step: verifying legitimacy, integrity, and validity of the received deposit information, data tree, and deposit transaction by using a public key of the user and a public key of the electronic contract platform;

When the verifying step is passed, a data block generating step is continued to be performed, to generate a data block based on the deposit information, the data tree, and the deposit transaction, and stamp the data block with a time stamp.

When the verifying step is not passed, the deposit process of the electronic contract ends.
a step of uploading and storing on a chain: uploading and storing the deposit information, the data tree, the deposit transaction, and the data block on a chain;
a transaction hash operation step: performing a hash operation on the deposit transaction, to obtain a transaction hash value;
a step of transmitting data back: transmitting the deposit information, the data tree, the deposit transaction, the data block, and the transaction hash value back to the electronic contract platform;
a step of continuing to transmit the data: transmitting the deposit information, the data tree, the deposit transaction, the data block, and the transaction hash value to a next deposit node;
a step of determining a number of deposit nodes: determining whether the number of the deposit nodes that complete the step of uploading and storing on a chain exceeds a preset number of deposit nodes; and
a step of completing a deposit process: when the number of the deposit nodes that complete the step of uploading and storing on a chain exceeds the preset number of deposit nodes, ending a deposit process of the electronic contract, and stopping performing the step of continuing to transmit the data.

When the number of the deposit nodes that complete the step of uploading and storing on a chain doesn't exceed the preset number of deposit nodes, the step of continuing to transmit the data is continued to be performed.

In another embodiment, the deposit node 23 may be further configured to perform:
a deposit time deciding step: deciding whether generation time of the data block exceeds preset deposit time; and
a step of completing a deposit process: when the generation time of the data block exceeds the preset deposit time, ending a deposit process of the electronic contract, and stopping performing the step of continuing to transmit the data. When the generation time of the data block exceeds the preset deposit time, meaning that there are sufficient blocks after the sequence number of this data block on the blockchain deposit platform. In other words, there are sufficient data blocks on the blockchain deposit platform which have deposited relevant data of the electronic contract.

When the generation time of the data block does not exceed the preset deposit time, the step of continuing to transmit the data is continued to be performed.

It should be noted that the deposit time deciding step and the step of deciding a number of deposit nodes are mutually replaceable, and it is possible to select one of the deposit deciding steps. The preset number of deposit nodes and the preset deposit time may be set in advance according to actual requirements. There is a need for sufficient number of deposit nodes on the blockchain to deposit the electronic contract, thus being able to ensure validity and credibility of deposit. Each deposit node needs to generate a new data block, and a time stamp may mark a time attribute of the data block. A subsequent deposit node needs to re-verify data transmitted by a previous deposit node. In this way, credibility of transmission data may be ensured. The step of deciding a number of deposit nodes and the deposit time deciding step are mutually replaceable, and it is possible to select one of them for execution. This is not specifically limited in this application. By setting the preset number of deposit nodes and the preset deposit time, validity and credibility of storing the electronic contract on the blockchain deposit platform may be ensured, being more efficient.

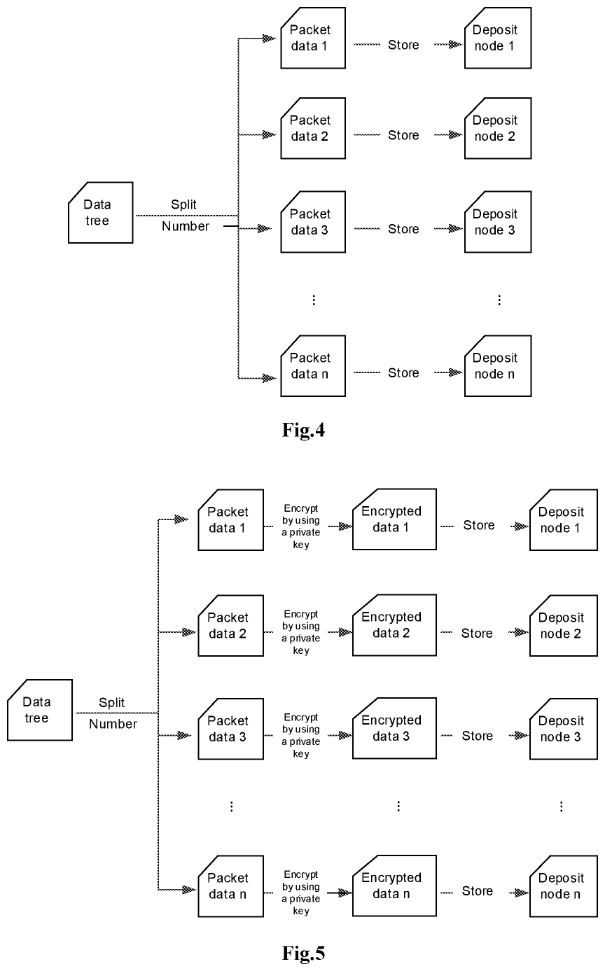

FIG. 4 is a corresponding flowchart of data splitting of a second transaction-based electronic contract deposit system according to an embodiment of this application. As shown in FIG. 4, according to the transaction-based electronic contract deposit system provided in this embodiment, at least one node of a blockchain deposit platform may serve as a data splitting node. The data splitting node is configured to perform a data splitting step, to split a received data tree, to obtain a plurality of pieces of packet data. The data tree may be split into n pieces of packet data. Subsequently, a numbering step is continued to be performed, to number each piece of the packet data, where the packet data may be numbered as packet data 1, packet data 2, packet data 3, packet data 4, . . . , and packet data n, and n is any positive integer. At this time, a deposit node is configured to perform a packet storing step, to store the corresponding packet data. One deposit node store one piece of packet data correspondingly. A step of continuing to transmit the data is continued to be performed after the storage is completed. For example, the packet data 1, the packet data 2, the packet data 3, the packet data 4, . . . , and the packet data n may be respectively stored in a deposit node 1, a deposit node 2, a deposit node 3, a deposit node 4, . . . , and a deposit node n.

In this embodiment, the data tree is obtained by encrypting and discretizing the deposit information. The blockchain deposit platform may split the data tree into a plurality of pieces of packet data. Storing the data tree on a plurality of nodes of the blockchain deposit platform in a decentralized way may further enhance security of storing the data tree on the blockchain deposit platform. When data of the data tree needs to be obtained as forensic data, the packet data may be reconstructed and decrypted.

FIG. 5 is a corresponding flowchart of data splitting of a third transaction-based electronic contract deposit system according to an embodiment of this application. As shown in FIG. 5, according to the transaction-based electronic contract deposit system provided in this embodiment, an electronic contract platform may be configured to perform a data splitting step, to split a data tree, to obtain a plurality of pieces of packet data. The data tree may be split into n pieces of packet data. Subsequently, a numbering and encrypting step is continued to be performed, to number each piece of the packet data, where the packet data may be numbered as packet data 1, packet data 2, packet data 3, packet data 4, . . . , and packet data n. By encrypting each piece of the packet data by using a private key of a user or a private key of the electronic contract platform, it is possible to obtain encrypted data which are numbered as encrypted data 1, encrypted data 2, encrypted data 3, encrypted data 4, . . . , and encrypted data n. A data sending step is continued to be performed after the encryption is completed. At this time, a deposit node is configured to perform a packet storing step, to store the corresponding packet data. One deposit node stores one piece of packet data correspondingly. A step of continuing to transmit the data is continued to be performed after the storage is completed. For example, the encrypted data 1, the encrypted data 2, the encrypted data 3, the encrypted data 4, . . . , and the encrypted data n may be respectively stored in a deposit node 1, a deposit node 2, a deposit node 3, a deposit node 4, . . . , and a deposit node n.

In this embodiment, the data tree is obtained by encrypting and discretizing deposit information. The electronic contract platform may split the data tree into a plurality of pieces of packet data. Because data transmission exists, the packet data needs to be encrypted. Storing the data tree on a plurality of nodes of the blockchain deposit platform in a decentralized way may further enhance security of storing the data tree on the blockchain deposit platform.

In addition, regarding uploading and storing on a chain of the blockchain deposit platform 2, whether a storage mode is storing original data synchronously, or merely storing a data digest of the original data or compressed data is not specifically limited in this application.

According to the transaction-based electronic contract deposit system provided in this application, the electronic contract platform is combined with the blockchain technology to deposit the electronic contract. The credibility of electronic contract deposit is ensured by using features of a blockchain, such as decentralization, cannot be tampered with, leaving tracks throughout the process, being traceable, being collectively maintained, and being open and transparent. By constructing the deposit transaction, a deposit behavior of uploading the electronic contract to the blockchain deposit platform is recorded. First, electronic contract data sent to the blockchain deposit platform is encrypted and discretized, and the data tree is generated, thereby being more beneficial to anti-tampering of the data, and enhancing security and privacy during a data transmission process. By means of signing by using the private key and verifying by using the public key, credibility of the deposit process of the electronic contract is further enhanced, to prevent the electronic contract from being tampered with and forged. When a contract dispute occurs, technically, it may be guaranteed that no party involved in the electronic contract can tamper with the contract.

For same or similar parts between the embodiments in this specification, reference may be made to each other.

What is claimed is:

1. A transaction-based electronic contract deposit system, comprising an electronic contract platform and a blockchain deposit platform, the blockchain deposit platform comprising a plurality of deposit nodes that provide deposit services for the electronic contract platform, wherein
the electronic contract platform is configured to perform:
a deposit information generating step: preprocessing an electronic contract, to obtain deposit information;
a data processing step: encrypting and discretizing the deposit information, to generate a corresponding data tree;
a transaction constructing step: constructing a deposit transaction, wherein an initiator of the deposit transaction is a user, a receiver is the electronic contract platform, and the deposit transaction is commonly signed by a private key of the user and a private key of the electronic contract platform; and
a data sending step: sending the deposit information, the data tree, and the deposit transaction to the blockchain deposit platform; and
the deposit node is configured to perform:
a verifying step: verifying legitimacy, integrity, and validity of the received deposit information, data tree, and deposit transaction by using a public key of the user and a public key of the electronic contract platform;
a data block generating step: generating a data block based on the deposit information, the data tree, and the deposit transaction, and stamping the data block with a time stamp;
a step of uploading and storing on a chain: uploading and storing the deposit information, the data tree, the deposit transaction, and the data block on a chain;
a transaction hash operation step: performing a hash operation on the deposit transaction, to obtain a transaction hash value;
a step of transmitting data back: transmitting the deposit information, the data tree, the deposit transaction, the data block, and the transaction hash value back to the electronic contract platform; and
a step of continuing to transmit the data: transmitting the deposit information, the data tree, the deposit transaction, the data block, and the transaction hash value to a next deposit node.

2. The transaction-based electronic contract deposit system according to claim 1, further comprising at least one account creating node that provides account creating services for the electronic contract platform, wherein
the account creating node is configured to perform:
an account deciding step: deciding whether there is a deposit platform account corresponding to the electronic contract platform on the blockchain deposit platform; and
an account creating step: when there is no deposit platform account corresponding to the electronic contract platform on the blockchain deposit platform, creating a deposit platform account for the electronic contract platform.

3. The transaction-based electronic contract deposit system according to claim 1, wherein the deposit node is further configured to perform:
a step of deciding a number of deposit nodes: deciding whether the number of the deposit nodes that complete the step of uploading and storing on a chain exceeds a preset number of deposit nodes; and
a step of completing a deposit process: when the number of the deposit nodes that complete the step of uploading and storing on a chain exceeds the preset number of deposit nodes, ending a deposit process of the electronic contract, and stopping performing the step of continuing to transmit the data.

4. The transaction-based electronic contract deposit system according to claim 1, wherein the deposit node is further configured to perform:
a deposit time deciding step: deciding whether generation time of the data block exceeds preset deposit time; and
a step of completing a deposit process: when the generation time of the data block exceeds the preset deposit time, ending a deposit process of the electronic contract, and stopping performing the step of continuing to transmit the data.

5. The transaction-based electronic contract deposit system according to claim 1, wherein the blockchain deposit platform further comprises at least one data splitting node;
the data splitting node is configured to perform:
a data splitting step: splitting the received data tree, to obtain a plurality of pieces of packet data; and
a numbering step: numbering each piece of the packet data;
the deposit node is configured to perform a packet storing step, to store the corresponding packet data; and the step of continuing to transmit the data is continued to be performed after the storage is completed.

6. The transaction-based electronic contract deposit system according to claim 1, wherein the electronic contract platform is further configured to perform:
a data splitting step: splitting the data tree, to obtain a plurality of pieces of packet data; and
a numbering and encrypting step: numbering each piece of the packet data, and encrypting each piece of the packet data by using the private key of the user or the private key of the electronic contract platform, wherein the data sending step is continued to be performed after the encryption is completed;
the deposit node is configured to perform a packet storing step, to store the corresponding packet data; and the step of continuing to transmit the data is continued to be performed after the storage is completed.

7. The transaction-based electronic contract deposit system according to claim 1, wherein the deposit information generating step specifically comprises:
a contract operating step: performing related operations on the electronic contract, to obtain a contract operation result, the related operations comprising signing, renewal, modification, and termination;
a certificate obtaining step: obtaining an electronic contract certificate corresponding to the contract operation result; and
a certificate signature scheme selecting step: selecting a signature scheme of the electronic contract certificate, and signing the electronic contract certificate, to obtain a signed certificate, the signature scheme comprising a local signature, an electronic contract platform signature, and a deposit platform signature; and
the deposit information comprises the contract operation result, the electronic contract certificate, and the signed certificate.

8. The transaction-based electronic contract deposit system according to claim 7, wherein the signature scheme at a certificate signing step comprises a local signature, an electronic contract platform signature, and a deposit platform signature; when the signature scheme is the local signature, the electronic contract certificate is signed by using the private key of the user, to obtain the signed certificate; and
the electronic contract platform is further configured to perform:
an uploading deciding step: deciding whether the electronic contract is to be deposited in the blockchain deposit platform; and when it is decided that the electronic contract is to be deposited in the blockchain deposit platform, continuing to perform the transaction constructing step.

9. The transaction-based electronic contract deposit system according to claim 7, wherein the signature scheme at a certificate signing step comprise a local signature, an electronic contract platform signature, and a deposit platform signature; when the signature scheme is the electronic contract platform signature, the electronic contract certificate is signed by using the private key of the electronic contract platform, to obtain the signed certificate; and
the electronic contract platform is further configured to perform:
an uploading deciding step: deciding whether the electronic contract is to be deposited in the blockchain deposit platform; and when it is decided that the electronic contract is to be deposited in the blockchain deposit platform, continuing to perform the transaction constructing step.

10. The transaction-based electronic contract deposit system according to claim 7, wherein the signature scheme at a certificate signing step comprises a local signature, an electronic contract platform signature, and a deposit platform signature; when the signature scheme is the deposit platform signature, the electronic contract certificate is signed by using a public key of the blockchain deposit platform, to obtain the signed certificate; and
the electronic contract platform is further configured to perform:
an uploading deciding step: deciding whether the electronic contract is to be deposited in the blockchain deposit platform; and when it is decided that the electronic contract is to be deposited in the blockchain deposit platform, continuing to perform the transaction constructing step.
